(19) United States
(12) Patent Application Publication
(10) Pub. No.: US 2023/0148626 A1
(43) Pub. Date: May 18, 2023

(54) PROTEIN-BASED FORMING AGENT, PREPARATION METHOD AND APPLICATION THEREOF

(71) Applicant: NORTHEAST AGRICULTURAL UNIVERSITY, Harbin (CN)

(72) Inventors: Juncai HOU, Harbin (CN); Zhanmei JIANG, Harbin (CN); Ruijie SHI, Harbin (CN); Tianzhu LI, Harbin (CN); Jinzhe LI, Harbin (CN)

(73) Assignee: NORTHEAST AGRICULTURAL UNIVERSITY, Harbin (CN)

(21) Appl. No.: 17/818,712

(22) Filed: Aug. 9, 2022

(30) Foreign Application Priority Data
Nov. 11, 2021 (CN) 202111333075.8

(51) Int. Cl. A23J 3/08; A23L 29/281; A23L 29/244

(52) U.S. Cl. CPC A23J 3/08; A23L 29/244; A23L 29/281; A23V 2002/00

(57) ABSTRACT

Disclosed in this specification are a protein-based foaming agent, its preparation method and application, and belong to the technical field of food additives. The foaming agent comprises raw materials of alpha-lactalbumin (α-La) and glycyrrhizic acid (GA), where a molar concentration ratio of α-La to GA in the protein-based foaming agent is 1 : (2.5-750); the foaming agent is prepared as follows: preparing α-La solution, adjusting pH, and then adding GA for reaction to obtain the protein-based foaming agent. In some embodiments of this specification, the α-La undergoes changes in terms secondary and tertiary structures by adjusting the pH of α-La solution, which promotes the development of protein molecules and increases the possibility of binding α-La with micromolecule surfactants; after α-La is bound with GA, the foaming ability and foam stability are greatly improved.

### CROSS-REFERENCE TO RELATED APPLICATIONS

This application claims priority to Chinese Patent Application No.202111333075.8, filed on Nov. 11, 2021, the contents of which are hereby incorporated by reference.

### TECHNICAL FIELD

This specification belongs to the technical field of food additives, and specifically relates to a protein-based foaming agent, its preparation method and application.

### BACKGROUND

Surfactants play a critical role in both forming and stabilizing interface-dominating food systems such as foams and emulsions; among them, food-derived proteins are natural surfactants and have received a lot of attention as the most promising alternatives. With excellent nutritional value and a wide range of functional properties, lactic proteins have shown potential in regulating the stability of interface-dominating food systems, yet their application in food systems is limited by their poor foam stability. A preferred technique to improve the foaming ability of lactic proteins is to incorporate small molecule surfactants.

Alpha-lactalbumin (α-La) has diverse functional properties and may be widely used in food processing as a foaming agent, emulsifier, thickener, gelling agent, etc.; however, the foaming ability and foam stability of α-La are not satisfactory when it is being used as a foaming agent; although there is study on adjusting foaming ability of α-La by adding surfactants, the foaming ability and foam stability of α-La has yet been significantly improved.

### SUMMARY

The present application provides a protein-based foaming agent, its preparation method and application so as to overcome the above problems in the prior art.

To achieve the above objectives, one or more embodiments of this specification provide the following technical solutions:

one or more embodiments of this specification provide a protein-based foaming agent, including alpha-lactalbumin (α-La) and glycyrrhizic acid (GA) as raw materials, and a molar concentration ratio of the α-La to GA in the protein-based foaming agent is in a range of 1 : (2.5 -750).

Optionally, the α-La in the protein-based foaming agent is in a concentration of 20 µm µmol/L, micromole/Liter).

One or more embodiments of this specification also provide a method for preparing the protein-based foaming agent, including the following steps: preparing α-La solution, adjusting a pH of the α-La solution to 2.5, and then adding GA for reaction to the pH-adjusted α-La solution to obtain the protein-based foaming agent.

GA, a functional plant triterpene saponin, is often used as a thickener or sugar substitute in foodstuffs owing to its various physiological functions, such as lowering blood sugar and regulating intestinal microflora.

α-La, after pH adjustment, undergoes changes in secondary and tertiary structures, facilitates unfolding of protein molecules, and increases potential of binding to small molecule surfactants.

Optionally, adjusting pH of the α-La solution is also followed by standing the pH-adjusted α-La solution for 10 - 15 hours (h).

Optionally, the reaction is carried out at room temperature for 20 - 40 minutes (min).

The above-mentioned protein-based foaming agent in some embodiments of this specification may also be applied in preparing foamed food.

Compared with the prior art, some embodiments of this specification have the following beneficial effects:

by adjusting the pH of the α-La solution, the α-La solution undergoes changes in its secondary and tertiary structures, which promotes the unfolding of protein molecules and increases the possibility of α-La binding with small molecule surfactants; compared with α-La without glycyrrhizic acid, the foaming ability and foam stability of the α-Lα-based foaming agent prepared in some embodiments of this specification is increased by up to 382.93 percent (%) and 65.96% respectively; with excellent foaming effect, the protein-based foaming agent prepared in some embodiments of this specification is suitable for adding to foamed foodstuffs.

### BRIEF DESCRIPTION OF THE DRAWINGS

In order to more clearly explain some embodiments of this specification or the technical solutions in the prior art, the following will briefly introduce the drawings that need to be used in the embodiments. Obviously, the drawings in the following description are only some embodiments of this specification. For those of ordinary skill in this field, other drawings may be obtained according to these drawings without any creative efforts.

FIG. 1 illustrates the influence of alpha-lactalbumin (α-La) on the aggregation of glycyrrhizic acid (GA).

FIG. 2 shows the effect of different pH conditions on the number of molecules of glycyrrhizic acid binding α-La.

FIG. 3 shows the effect of different GA adding ratios on the surface hydrophobicity of α-La.

FIG. 4 shows the effect of different GA adding ratios on the turbidity of α-La.

FIG. 5 shows the result of the influence of different GA adding ratios on the static rheology of α-La, where FIG. 5 (a) and (b) are the measurement results of the static rheological properties of foaming agents prepared with different GA adding ratios in Embodiment 1 and Embodiment 2, respectively.

FIG. 6 is a graph showing the effect of different GA adding ratios on the dynamic rheological properties, where FIG. 6 (a) and (b) are the measurement results of the dynamic rheological properties of foaming agents prepared with different GA adding ratios in Embodiment 1 and Embodiment 2, respectively.

FIG. 7 shows the result of the influence of different GA adding ratios on the foaming ability and foam stability of α-La.In FIG. 7, (a) shows the results of calculating foaming ability of foaming agent with different GA adding ratios, and (b) shows the results of calculating foam stability of foaming agent with different GA adding ratios.

FIG. 8 shows the results of the effect of different GA adding ratios on the foam microstructure of α-La, where (a) in FIG. 8 shows the foam microstructure of α-La with pH of 7.0 and α-La/GA with different ratios of GA, (b) in FIG. 8 shows the foam microstructure of α-La with pH of 2.5 and α-La/GA with different ratios of GA, (c) in FIG. 8 shows the microstructure of foam with single GA of different concentrations while with pH of 7.0, and (d) in FIG. 8 shows the foam microstructure of single GA with different concentrations while with pH of 2.5.

FIG. 9 (i) and FIG. 9 (ii) are the foam interface graphs of foaming agents prepared in Embodiment 1 and Embodiment 2 with different adding ratios of GA, respectively. In the graphs, (a) - (b) are the interface graphs of bubbles at different magnifications when the concentration of GA is 0 mM (mmol/L, millimole/Liter), (c) - (d) are the interface graphs of bubbles at different magnifications when the concentration of GA is 3 mM, and (e) - (f) are the interface graphs of bubbles at different magnifications when the concentration of GA is 10 mM.

### DETAILED DESCRIPTION OF THE EMBODIMENTS

Now, various exemplary embodiments of this specification will be described in detail. This detailed description should not be taken as a limitation of this specification, but should be understood as a more detailed description of some aspects, features and embodiments of this specification. It should be understood that the terms in this specification are only used to describe specific embodiments, and are not used to limit the invention.

In addition, for the numerical range in this specification, it should be understood that each intermediate value between the upper limit and the lower limit of the range is also specifically disclosed. Every smaller range between any stated value or intermediate value within stated range and any other stated value or intermediate value within stated range is also included in this specification. The upper and lower limits of these smaller ranges can be independently included or excluded from the range.

Unless otherwise stated, all technical and scientific terms used herein have the same meanings commonly understood by those of ordinary skill in the field to which this invention relates. Although this specification only describes preferred methods and materials, any methods and materials similar or equivalent to those described herein can be used in the implementation or testing of this specification. All documents mentioned in this specification are incorporated by reference to disclose and describe the methods and/or materials related to the documents. In case of conflict with any incorporated documents, the contents of this specification shall prevail.

Without departing from the scope or spirit of the present invention, it is obvious to those skilled in the art that many modifications and changes can be made to the specific embodiments of the present specification. Other embodiments obtained from the description of the present invention will be obvious to the skilled person. The description and embodiment of that invention are only exemplary.

As used in this paper, the terms “comprising”, “including”, “having” and “containing” are all open terms, meaning including but not limited to.

In the following embodiments, alpha-lactalbumin (α-La) is purchased from Davisco Foods International, and glycyrrhizic acid (GA) is purchased from Shanghai Yuanye BioTechnology Co., Ltd.

### Embodiment 1

A protein-based foaming agent is prepared as follows:

preparing an α-La solution with a concentration of 20 µM (µmol/L, micromole/Liter) with phosphate buffer solution (PBS, 10 mmol/L (millimole/Liter), pH 7.0), continuously stirring the prepared α-La solution for 3 hours (h), adjusting the pH of the stirred α-La solution to 7 with sodium hydroxide solution, standing the pH-adjusted α-La solution for 12 h; adding different amounts of GA into the α-La solution after standing, and uniformly mixing and stirring the solution for reaction at room temperature to obtain a mixed solution, namely protein-based foaming agent.

In some embodiments, the protein-based foaming agent includes α-La and GA as raw materials, and a molar concentration ratio of α-La to GA in the protein-based foaming agent is in a range of 1 : (2.5 - 750); in some embodiments, the molar concentration ratio of α-La to GA is in a range of 1 : (1 - 800); in some embodiments, the molar concentration ratio of α-La to GA is in a range of 1 : (5 - 700); in some embodiments, the molar concentration ratio of α-La to GA is in a range of 1 : (10 - 600); in some embodiments, the molar concentration ratio of α-La to GA is in a range of 1 : (15 - 550); in some embodiments, the molar concentration ratio of α-La to GA is in a range of 1 : (20 - 500); in some embodiments, the molar concentration ratio of α-La to GA is in a range of 1 : (25 - 450); in some embodiments, the molar concentration ratio of α-La to GA is in a range of 1 : (30 - 400); in some embodiments, the molar concentration ratio of α-La to GA is in a range of 1 : (35 - 350); in some embodiments, the molar concentration ratio of -La to GA is in a range of 1 : (40 - 300); in some embodiments, the molar concentration ratio of α-La to GA is in a range of 1 : (45 - 250); in some embodiments, the molar concentration ratio of α-La to GA is in a range of 1 : (50 - 200); in some embodiments, the molar concentration ratio of α-La to GA is in a range of 1 : (1 - 800); in some embodiments, the molar concentration ratio of α-La to GA is in a range of 1 : (55 - 150); and in some embodiments, the molar concentration ratio of α-La to GA is in a range of 1 : (60 - 100).

In some embodiments, adjusting the pH of the stirred solution is followed by standing the α-La solution for 5 - 20 h; in some embodiments, adjusting the pH of the stirred solution is followed by standing the α-La solution for 10 - 15 h; in some embodiments, adjusting the pH of the stirred solution is followed by standing the α-La solution for 11 - 14 h; and in some embodiments, adjusting the pH of the stirred solution is followed by standing the α-La solution for 12 - 13 h.

In some embodiments, the reaction is carried out at room temperature for 20 - 40 minutes (min); in some embodiments, the reaction is carried out at room temperature for 30 min; in some embodiments, the reaction is carried out at room temperature for 20 - 30 min; and in some embodiments, the reaction is carried out at room temperature for 30 - 40 min.

### Embodiment 2

A protein-based foaming agent is prepared as follows:

preparing an α-La solution with a concentration of 20 µM with phosphate buffered saline (PBS) of 10 mmol/L and pH of 7.0, continuously stirring the prepared α-La solution for 3 h, adjusting the pH of the stirred solution to 2.5, standing the pH-adjusted solution for a period of time; adding different amounts of GA into the α-La solution after standing, and uniformly mixing and stirring the solution for reaction at room temperature to obtain a mixed solution, namely protein-based foaming agent. For the molar concentration ratio of α-La to GA in protein-based foaming agent, the standing duration of α-La solution after pH adjustment, reaction duration, etc., please refer to the corresponding contents of Embodiment 1.

### Embodiment 3

### Interaction Between GA and α-La

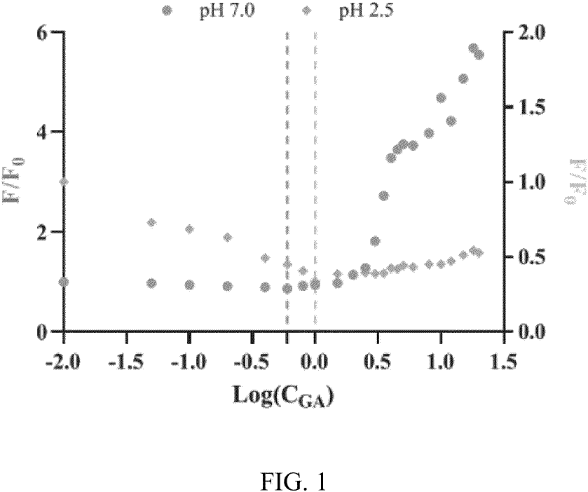

Measurement of aggregation: adding 8-Anilino-1-naphthalenesulfonic acid (ANS) solution (80 microliter (µL), 8 mmol/L) into 4 milliliter (mL) of the mixed solutions prepared in Embodiment 1 and Embodiment 2, respectively, and standing the solutions in the dark for 15 min; measuring the aggregation with a 1 centimeter (cm) light path cuvette, setting the excitation/emission slit of the instrument to 5.0/2.5 nano-meter (nm), the excitation wavelength at 355 nm, and recording the emission spectrum as 360 - 600 nm; recording the value of the most fluorescent intensity. The results of measuring aggregation of GA in the presence of α-La with F/F0 as an index are shown in FIG. 1.

It is necessary to understand how the protein affects the aggregation of GA molecules before elucidating the detailed study of α-La and GA interactions. As shown in FIG. 1, the intrinsic fluorescence intensity of α-La first decreases and then increases with the increase of GA concentration from 0 to 15.00 mM in neutral and acidic solutions with the presence of ANS, where the decrease of the intrinsic fluorescence intensity of α-La is mainly due to the competitive binding between GA molecule and ANS probe in the hydrophobic region of α-La.In some embodiments, there is interaction between GA and α-La, which is beneficial to the formation of polymers between GA and α-La.As shown in FIG. 1, the decrease of fluorescence intensity of ANS probe, in some embodiments, is due to the change of total GA concentration, rather than the change of free GA concentration.

The fluorescence intensity is related to the fluorescence quantum yield (φ_{f}), which refers to the ratio of the number of photons of fluorescence emitted by fluorescent substances after absorbing light to the number of photons of excitation light absorbed. Usually, the value of φ_{f} is less than 1, and the greater the value, the stronger the fluorescence of the compound, while the value of φ_{f} of the non-fluorescent substance is equal to or very close to zero. In this embodiment, the φ_{f} of ANS probe combined with α-La is much lower than that in GA polymer. Therefore, the φ_{f} of protein bound to ANS increases at higher GA concentration since the φ_{f} of bound ANS probe in aggregate is much larger than that of ANS probe bound to protein. In some embodiments, GA may compete with ANS to bind α-La, and GA may significantly increase the fluorescence intensity of ANS.

### Embodiment 4

### Effect of pH on Aggregation of GA

The threshold concentration required to form small molecular aggregates on the surface of protein is called critical aggregation concentration (CAC), which is usually lower than critical micelle concentration (CMC). On this basis, it is also found that in the presence of α-L, the breakpoints (i.e., CAC) in FIG. 1 differ from that in the conditions of pH. For example, the minimum value of fluorescence of α-La is recorded under neutral condition and 1.0 mM GA, while the minimum value is observed after adding 2.0 mM GA in acid solution; this is because the pH of the original solution of GA is 4.3, while the carboxylate of GA is protonated and its electrostatic charge is shielded when the pH is 2.5, which leads to the decrease of repulsion between GA molecules and promotes self-assembly of molecules to form aggregates; GA is easier to polymerize under acidic conditions when the concentration of α-La is constant, that is, it has a smaller CAC. The smaller the CAC, or CMC, the more stable the aggregate, so the foaming agent prepared under acidic conditions is rather stable.

### Embodiment 5

### Effect of Different pH Conditions on the Number of Molecules of Glycyrrhizic Acid Binding α-La

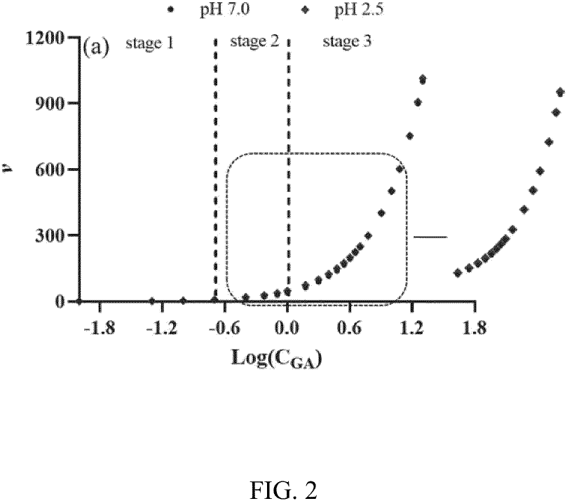

Determination of the number of molecules of glycyrrhizic acid binding α-La: under 25 degree Celsius (°C) and fixed concentration of α-La of 20 µmol/L, adjusting the concentration of GA (0 - 15.0 mM) to obtain a α-La-GA mixed solution; calculating an average value (v) of each protein molecule bound to surfactant molecules by measuring the endogenous fluorescence (λₑₓ = 295 nm) of α-La-GA mixed solution, and obtaining a binding isotherm from the change of the average number with the total concentration of GA as shown in FIG. 2.

Binding isotherm allows a good understanding of protein-glycyrrhizic acid binding behavior, with the average value (v) of glycyrrhizic acid molecules bound per protein molecule as the response value being used as a criterion for determination. Generally speaking, the binding isotherm shows three characteristic regions: (i) specific binding, (ii) non-synergistic binding and (iii) synergistic binding. As can be seen from FIG. 2, region I includes an area with a GA concentration from 0 to 0.20 mM; in this region, the binding isotherm increases slowly, which may be caused by the specific binding between GA and α-La; in addition, it is also observed that pH has no significant effect on the binding isotherm of α-La and GA in this region. In the region II of 0.02<C_{GA}<1.00 mM, the average value v of bound GA molecules increases slowly but obviously, where the maximum fluorescence intensity is decreased. In the region III between 1.00 mM and 15.00 mM, a large number of synergistic binding appears with the formation of protein aggregates. Moreover, the values v under different pH conditions vary greatly in regions II and III (see Table 1). Acidic conditions can induce more GA molecules to bind with α-La in the process of non-cooperative binding and cooperative binding, which may be due to the fact that the structure of α-La is unfolded under acidic conditions, prompting more hydrophobic groups to be exposed, thus making α-La binding with more GA molecules.

TABLE 1

Difference between the average value of GA molecules under different pH conditions

| pH | Characteristic area | C_{GA}/mol·L⁻¹ | v |
|---|---|---|---|
| 7.0 | I | 0 - 0.20 | 0 - 5.22 |
| | II | 0.20-1.00 | 5.22 - 39.49 |
| | III | 1.00-15.00 | 39.49 - 998.19 |
| 2.5 | I | 0 - 0.20 | 0 - 8.96 |
| | II | 0.20 - 1.00 | 8.96 - 48.95 |
| | III | 1.00 - 15.00 | 48.95 1,014.96.00 |

When the pH is 7.0, the average value v of GA molecules bound in the region I of 0<C_{GA}<0.20 mM (corresponding to the molar concentration ratio of α-La to GA greater than 1 : 100) is 0 - 5.22, the average value v of GA molecules bound in the region II of 0.02<C_{GA}<1.00 mM (corresponding to the molar concentration ratio of α-La to GA of 1 : 1 to 1 : 50) is 5.22 -39.49, and the average value v of GA molecules bound in the region III of 1.00<C_{GA}<15.00 mM (equivalent to the molar concentration ratio of α-La to GA of 1:50 to 1:750) is 39.49 - 998.19. When the pH is 2.5, the average value v of GA molecules bound in the region I of 0<C_{GA}<0.20 mM (corresponding to the molar concentration ratio of α-La to GA greater than 1 : 100) is 0 - 8.96, the average value v of GA molecules bound in the region II of 0.02<C_{GA}< 1.00 mM (corresponding to the molar concentration ratio of α-La to GA of 1 : 1 to 1 : 50) is 8.96 - 48.95, and the average value v of GA molecules bound in the region III of 1.00<C_{GA}<15.00 mM (equivalent to the molar concentration ratio of α-La to GA of 1 : 50 to 1 : 750) is 48.95 - 1,014.96.00. When the pH is 2.5, the average value v of the GA molecules bound in the region III of 1.00<C_{GA}<15.00 mM (equivalent to the molar concentration ratio of α-La to GA of 1 : 50 to 1 : 750) is 48.95 - 1,014.96.00, and the binding results are relatively good. In some embodiments, when the concentration of GA is the same under acidic conditions, the average value of GA molecules bound to each same protein molecule is basically larger than that under neutral conditions, indicating that the foaming agent prepared under acidic conditions is able to save the amount of GA while maintaining a balanced foaming effect.

### Embodiment 6

### Effect of Different GA Adding Ratios on Surface Hydrophobicity of α-La

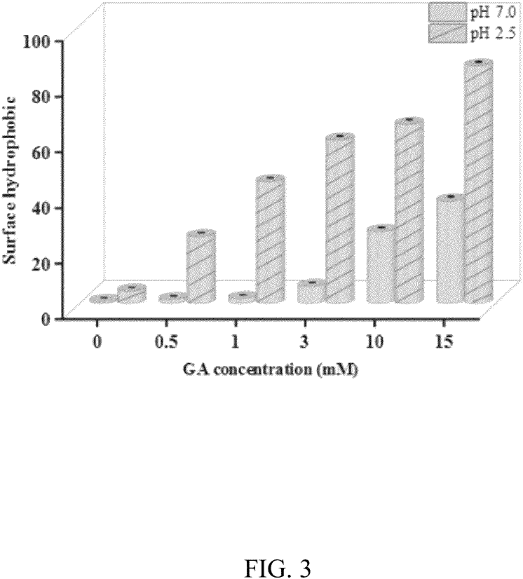

Determination of surface hydrophobicity of α-La: diluting the protein-based foaming agent samples prepared in Embodiments 1 to 2 to 0.2 - 1.0 mg/mL with PBS (pH of 7.0, concentration of 0.01 mol/L), adding 20 µL of ANS solution (concentration of 8 mmol/L) to 4 mL of the diluted protein samples, shaking and mixing the samples well, and reacting at dark for 15 min; setting the excitation wavelength at 390 nm, the emission wavelength at 470 nm and the slit width at 5 nm, setting the excitation wavelength at 390 nm, the emission wavelength at 470 nm and the slit width at 5 nm, conducting a linear regression analysis with the measured fluorescence intensity as the vertical coordinate and the protein concentration as the horizontal coordinate, where the initial slope obtained is the surface hydrophobicity of the protein sample. The results are shown in Table 2 and FIG. 3.

TABLE 2

Effect of different GA adding ratios on surface hydrophobicity of α-La

| Group | | GA concentration/mM | | | | | |
|---|---|---|---|---|---|---|---|
| | | 0 | 0.5 | 1.0 | 3.0 | 10.0 | 15.0 |
| Surface hydrophobicity | Embodiment 1 | 0.66 | 1.32 | 1.69 | 6.12 | 25.84 | 36.74 |
| | Embodiment 2 | 4.37 | 24.03 | 43.66 | 58.62 | 64.3 | 85.29 |

When GA is of 0 mM, the surface hydrophobicity of Embodiment 1 is 0.66 and that of Embodiment 2 is 4.37; when GA is of 0.5 mM (equivalent to the molar concentration ratio of α-La to GA of 1 : 25), the surface hydrophobicity of Embodiment 1 is 1.32 and that of Embodiment 2 is 24.03; when GA is of 1.0 mM (equivalent to the molar concentration ratio of α-La to GA of 1 : 50), the surface hydrophobicity of Embodiment 1 is 1.69 and that of Embodiment 2 is 43.66; when GA is of 3.0 mM (equivalent to the molar concentration ratio of α-La to GA of 1 : 150), the surface hydrophobicity of Embodiment 1 is 6.12 and that of Embodiment 2 is 58.62; when GA is of 10.0 mM (equivalent to the molar concentration ratio of α-La to GA of 1 : 500), the surface hydrophobicity of Embodiment 1 is 25.84 and that of Embodiment 2 is 64.3; when GA is of 15.0 mM (equivalent to the molar concentration ratio of α-La to GA of 1 : 750), the surface hydrophobicity of Embodiment 1 is 36.74 and that of Embodiment 2 is 85.29. It can be seen from Table 2 and FIG. 3 that the GA increases the surface hydrophobicity of α-La (p<0.05). This may be due to the introduction of hydrophobic group of GA, which reduces the polarity of the surrounding solution in α-La/GA composite, and with the increase of GA concentration, the effect of GA on the surface hydrophobicity of α-La becomes more obvious (p<0.05). In some embodiments, increased surface hydrophobicity inhibits foam disproportionation, resulting in a finer foam that does not collapse as quickly, and therefore increased hydrophobicity leads to increased foam stability. In some embodiments, the molar concentration ratio of α-La to GA is between 1 : 25 and 1 : 750; and in some embodiments, the molar concentration ratio of α-La to GA is 1 : 750. It can be seen from Embodiment 6 that the surface hydrophobicity of α-La is relatively high when the molar concentration ratio of α-La to GA is 1 : 750 and pH is 2.5.

### Embodiment 7

### Effect of Different GA Adding Ratios on Turbidity of α-La

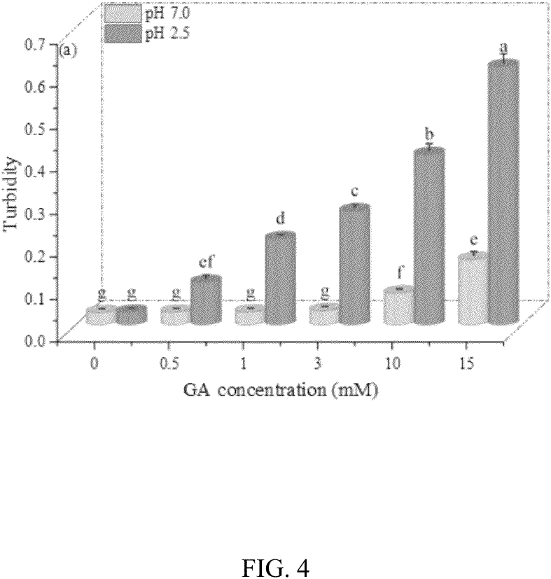

Measurement of the turbidity of foaming agent: adding 50 µL of the newly prepared mixed solution of Embodiment 1 and Embodiment 2 into 5 mL of sodium dodecyl sulfate (SDS) with a volume fraction of 0.1 percent (%), followed by thoroughly mixing, measuring the absorbance value at 500 nm and recording the value as A₅₀₀, where the A₅₀₀ is the turbidity of the solution. The results are shown in Table 3 and FIG. 4.

TABLE 3

Effect of different GA adding ratios on turbidity of α-La

| Group | | Concentration of GA/mM | | | | | |
|---|---|---|---|---|---|---|---|
| | | 0 | 0.5 | 1.0 | 3.0 | 10.0 | 15.0 |
| Turbidity | Embodiment 1 | 0.0287 | 0.0297 | 0.0300 | 0.0333 | 0.0747 | 0.1540 |
| | Embodiment 2 | 0.0300 | 0.1003 | 0.2030 | 0.2677 | 0.4007 | 0.6077 |

When GA is of 0 mM, the turbidity of Embodiment 1 is 0.0287 and that of Embodiment 2 is 0.0300; when GA is of 0.5 mM (equivalent to the molar concentration ratio of α-La to GA of 1 : 25), the turbidity of Embodiment 1 is 0.0297 and that of Embodiment 2 is 0.1003; when GA is of 1.0 mM (equivalent to the molar concentration ratio of α-La to GA acid of 1 : 50), the turbidity of Embodiment 1 is 0.0300 and that of Embodiment 2 is 0.2030; when GA is of 3.0 mM (equivalent to the molar concentration ratio of α-La to GA of 1 : 150), the turbidity of Embodiment 1 is 0.0333 and that of Embodiment 2 is 0.2677; when GA is of 10.0 mM (equivalent to the molar concentration ratio of α-La to GA of 1 : 500), the turbidity of Embodiment 1 is 0.0747 and that of Embodiment 2 is 0.4007; and when GA is of 15.0 mM (equivalent to the molar concentration ratio of α-La to GA of 1 : 750), the turbidity of Embodiments 1 is 0.1540 and that of Embodiment 2 is 0.6077. It can be seen from Table 3 and FIG. 4 that the turbidity of the sample remains unchanged when the α-La solution is neutral and the GA concentration is in the range of 0 - 3.00 mM, while when the GA concentration is 10.00 mM (equivalent to the molar concentration ratio of α-La to GA of 1 : 500), the turbidity of the sample increases significantly, which is 160.45% higher than that of α-La alone (P < 0.05). This change is accompanied by the change of color and transparency of the solution. In this case, the GA molecules present in solution are all aggregates apart from those bound to α-La.Whereas an α-La solution with a pH of 2.5 has a greater effect on the turbidity of the composite; for example, when the GA concentration is 15.0 mM, the turbidity of α-La solution increases by 437.15% when the pH is 7.0, while the turbidity increases by 1,925.57% when the pH is 2.5 (P < 0.05), which indicates that there is a high degree of aggregation in acidic solution; on this occasion, especially when 15.0 mM GA is added, the composite solution is white and opaque; therefore, the binding interaction between -La and GA in acidic solution is proved to be stronger than that in neutral solution; besides, the carboxylate of GA is protonated in acidic solution, and the electrostatic charge of GA is shielded, which reduces the repulsion between GA molecules and promotes self-assembly of GA molecules to form more aggregates. In some embodiments, the molar concentration ratio of α-La to GA is 1 : 750. As can be seen from Embodiment 7, the sample has a high degree of aggregation when the molar concentration ratio of α-La to GA of 1 : 750 and pH of 2.5.

### Embodiment 8

### Effect of Different GA Adding Ratios on Static Rheology of α-La

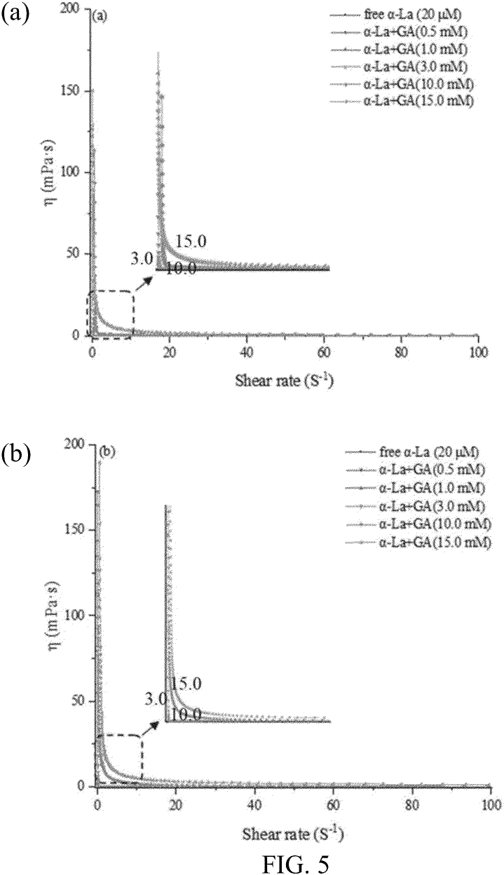

Determination of static rheological properties of foaming agent: measuring rheological properties of the mixed solutions with different GA adding ratios prepared in Embodiments 1 - 2 by RST rheometer while controlling the temperature at 25° C., the shear rate at 0.1 - 100 s⁻¹, recording the shear stress and apparent viscosity; the results are shown in FIG. 5, where (a) and (b) are the measurement results of static rheological properties of foaming agents prepared in Embodiment 1 and Embodiment 2, respectively. FIG. 5 also shows the apparent viscosity results of α-La/GA composite at different pH values; when the GA concentration is 0 - 1.00 mM (equivalent to the molar concentration ratio of -La to GA greater than 1 : 50), the apparent viscosities of-La alone and combined -La are measured, but no data are observed, probably due to the low viscosity of the solution; however, when GA of more than 3.00 mM (equivalent to the molar concentration ratio of α-La to GA less than 1 : 150) is added, the apparent viscosity of the bound α-La decreases with the increase of shear rate, which indicates that α-La/GA composite exhibits mild shear thinning behavior at pH 7.0 and pH 2.5; and when GA of 15.00 mM (equivalent to the molar concentration of α-La and GA of 1 : 750) is added, the value of apparent viscosity is relatively high; moreover, the apparent viscosity of the complex at pH 2.5 is higher than at pH 7.0 under the same GA concentration; under acidic conditions, the random aggregation of GA molecules is promoted and greater flow resistance is produced as comparing to neutral conditions, indicating that acidic conditions can increase the shear sensitivity of the composite, thus making the foam more stable. In some embodiments, the molar concentration ratio of α-La to GA ranges from 1 : 150 to 1 : 750, and it can be seen from Embodiment 8 that the apparent viscosity is relatively high when the molar concentration ratio of α-La to GA is 1 : 750, and the pH is 2.5.

### Embodiment 9

### Effect of Different GA Adding Ratios on Dynamic Rheology of α-La

Determination of dynamic rheological properties of foaming agent: measuring the rheological properties of the mixed solutions with different GA adding ratios prepared in Embodiments 1 - 2 by RST rheometer while controlling the temperature at 25° C., the frequency of dynamic modulus of the sample in the range of 0.01 hertz (Hz) to 10 Hz, and the scanning constant strain amplitude at 0.3%.

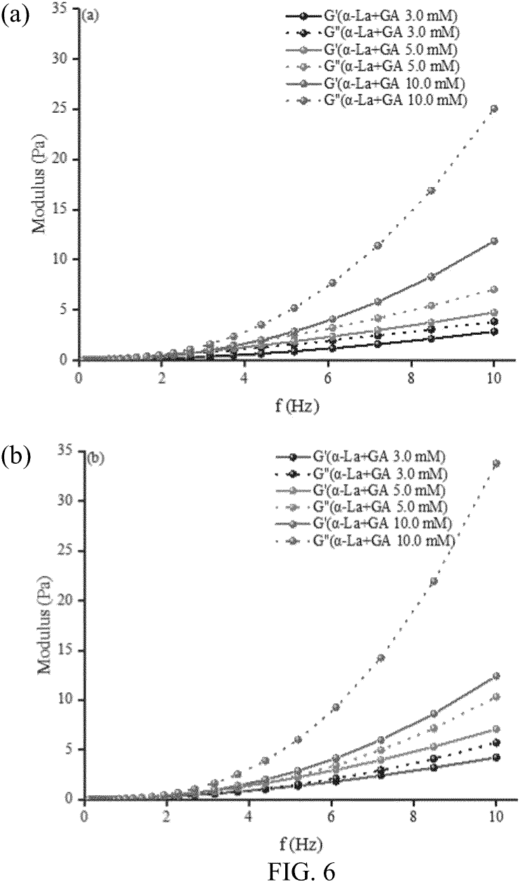

The results of measuring dynamic rheological properties of α-La/GA mixed solutions prepared in Embodiments 1 - 2 are shown in (a) and (b) of FIG. 6, respectively; as can be seen form the FIG. 6, the G′ of the composite is always higher than G″ under acidic and neutral conditions in the frequency range of 0.01 - 10 Hz; there is no intersection between G′ and G″, meaning that there is a weak gel network structure in all samples; moreover, the G′ and G″ values of all samples show frequency dependence, indicating that G′ and G″ increase with the increase of frequency values. The G′ and G″ values of α-La in the presence of 10.0 mM GA are significantly higher than that in other GA concentrations at pH 7.0 and pH 2.5 (p<0.05). In some embodiments, the molar concentration ratio of α-La to GA is 1 : 500, and it can be seen from Embodiment 9 that the G′ is relatively high and the dynamic rheology is good when the molar concentration ratio of α-La to GA is 1 : 500 and the pH value is adjusted to 2.5.

### Embodiment 10

### Effect of Different GA Adding Ratios on Foaming Ability and Foam Stability of α-La

Measurement of foaming ability and foam stability: adding 15 mL of the sample solutions (V) prepared in Embodiments 1 - 2 into a measuring cylinder with a volume of 100 mL, homogenizing the solutions with a high-speed emulsifying machine at 10,000 revolutions per min (rpm) for 2 min, immediately recording a volume of foam (V₀) at 0 min after homogenization, and recording a volume of foam (V₃₀) after the mixture is allowed to stand for 30 min; using the following formulas (1) and (2) to calculate the foaming ability (FA) and foam stability (FS):

$$\text{FA} \left(\%\right) = \frac{{V}_{o}}{V} \times 100 \%$$

$$\text{FS} \left(\%\right) = \frac{{V}_{30}}{{V}_{o}} \times 100 \%$$

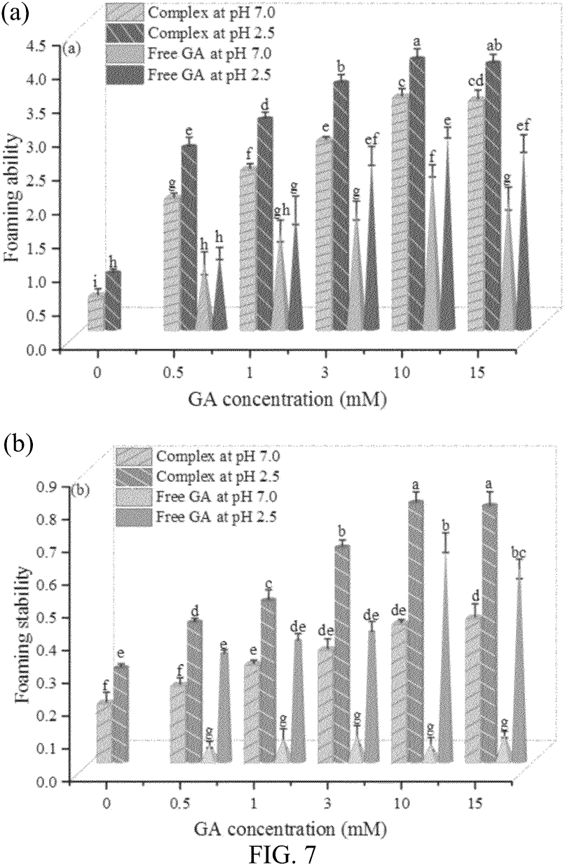

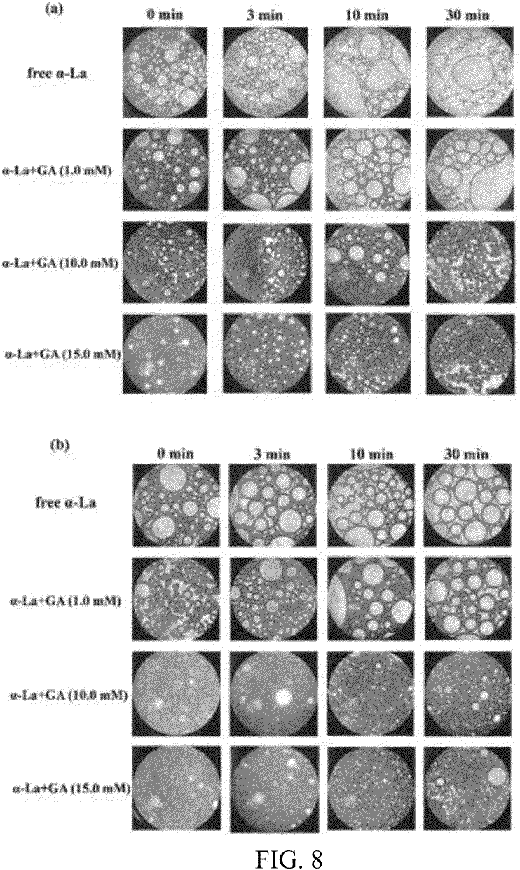

The results of calculating foaming ability are shown in Table 4 and FIG. 7 (a), and the results of calculating foam stability are shown in Table 5 and FIG. 7 (b).

TABLE 4

Effect of different GA adding ratios on foaming ability of α-La

| Group | | Concentration of GA/mM | | | | | |
|---|---|---|---|---|---|---|---|
| | | 0 | 0.5 | 1.0 | 3.0 | 10.0 | 15.0 |
| FA/% | Embodiment 1 | 0.5000 | 1.9444 | 2.3684 | 2.8000 | 3.4409 | 3.3979 |
| | Embodiment 2 | 0.8333 | 2.7000 | 3.1111 | 3.6471 | 4.0000 | 3.9367 |

TABLE 5

| Group | | Concentration of GA/mM | | | | | |
|---|---|---|---|---|---|---|---|
| | | 0 | 0.5 | 1.0 | 3.0 | 10.0 | 15.0 |
| FS/% | Embodiment 1 | 0.1800 | 0.2343 | 0.2978 | 0.3429 | 0.4219 | 0.4400 |
| | Embodiment 2 | 0.2867 | 0.4259 | 0.4929 | 0.6549 | 0.7917 | 0.7818 |

When GA is of 0 mM, the foaming ability (FA) of Embodiment 1 is 0.5000% and that of Embodiment 2 is 0.8333%, and the foam stability (FS) of Embodiment 1 is 0.1800% and that of Embodiment 2 is 0.2867%. When GA is 0.5 mM (equivalent to the molar concentration ratio of α-La to GA of 1 : 25), the foaming ability (FA) of Embodiment 1 is 1.9444% and that of Embodiment 2 is 2.7000%, and the foam stability (FS) of Embodiment 1 is 0.2343% and that of Embodiment 2 is 0.4259%. When GA is 1.0 mM (equivalent to the molar concentration ratio of α-La to GA of 1 : 50), the foaming ability (FA) of Embodiment 1 is 2.3684% and that of Embodiment 2 is 3.1111%, and the foam stability (FS) of Embodiment 1 is 0.2978% and that of Embodiment 2 is 0.4929%. When GA is 3.0 mM (equivalent to the molar concentration ratio of α-La to GA of 1 : 150), the foaming ability (FA) of Embodiment 1 is 2.8000% and that of Embodiment 2 is 3.6471%, and the foam stability (FS) of Embodiment 1 is 0.3429% and that of Embodiment 2 is 0.6549%. When GA is 10.0 mM (equivalent to the molar concentration ratio of α-La to GA of 1 : 500), the foaming ability (FA) of Embodiment 1 is 3.4409% and that of Embodiment 2 is 4.0000%, and the foam stability (FS) of Embodiment 1 is 0.4219% and that of Embodiment 2 is 0.7917%. When GA is 15.0 mM (equivalent to the molar concentration ratio of α-La to GA of 1 : 750), the foaming ability (FA) of Embodiment 1 is 3.3979% and that of Embodiment 2 is 3.9367%, and the foam stability (FS) of Embodiment 1 is 0.4400% and that of Embodiment 2 is 0.7818%.

As can be seen from Tables 4 - 5 and (a) - (b) in FIG. 7, the foaming ability and foam stability of protein both show an upward trend with the increase of GA adding ratio; when the GA is of 10.0 mM (equivalent to the molar concentration ratio of α-La to GA of 1 : 500), the foaming ability and foam stability of acidic-pretreated α-La are the highest, which are 42.19% and 78.06% respectively, increased by 382.93% and 65.96% respectively as being compared with that of acidic pretreated α-La without GA, indicating that GA is beneficial to improve the foaming characteristics of protein; while in the case of no GA is added, the foaming ability and foam stability of the protein pretreated by acid are higher than those of the protein pretreated in neutral condition, with increasing of 133.74% and 59.26% respectively. Protein molecules treated by acid can diffuse and adsorb to the gas-liquid interface rather quickly, and can stretch and rearrange quickly after reaching the interface, forming an adsorption film with strong cohesion and viscoelasticity through the interaction between molecules, resulting in increased foaming characteristics of the protein. In some embodiments, the foaming ability and foam stability of protein can be adjusted by controlling the adding ratio of GA; for example, when the adding amount of GA is 10.0 mM (equivalent to the molar concentration ratio of α-La to GA of 1 : 500), the foaming ability and foam stability of protein are relatively high, where the dosage of GA is reasonably controlled while ensuring the foaming ability and foam stability of protein reaching the expected effect.

In some embodiments, the molar concentration ratio of α-La to GA is 1 : 500. It can be seen from Embodiment 10 that when the molar concentration ratio of α-La to GA is 1 : 500 and the pH value is adjusted to 2.5, the dosage of GA is relatively low, the surface hydrophobicity of α-La as well as the viscosity is rather high, the aggregation degree of the compound is relatively high and the foaming ability and foam stability are rather good; such a good performance in terms of surface hydrophobicity, sample aggregation and apparent viscosity can also be seen in other experiments where the molar concentration ratio of α-La to glycyrrhizic acid is 1:500. In some embodiments, the molar concentration ratio of α-La to GA is 1 : 750. It can be seen from Embodiment 10 that when the pH value is adjusted to 2.5, the GA added is required to be in a rather high dosage, and the α-La has rather surface hydrophobicity as well viscosity, the aggregation degree of the compound relatively high and the foaming ability and foam stability are rather good.

### Embodiment 11

### Effect of Different GA Adding Ratios on Microstructure of α-La Foam

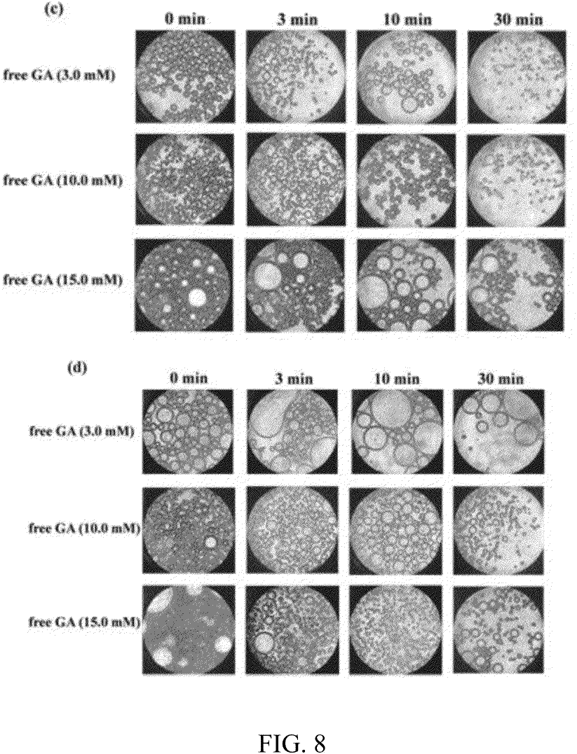

Observation of microstructure of the foaming agent: observing the microstructure of different foaming agent samples prepared in Embodiments 1-2 by optical microscope; the observed results are shown in FIG. 8, in which (a) shows the foam microstructure of α-La/GA with pH7.0 and GA with concentrations of 1.0 mM, 10.0 mM and 15.0 mM respectively, (b) shows foam microstructure of α-La/GA with pH2.5 and GA with concentrations of 1.0 mM, 10.0 mM and 15.0 mM respectively, (c) shows the foam microstructure of GA alone with pH7.0 concentration of 3.0 mM, 10.0 mM and 15.0 mM respectively, and (d) shows the foam microstructure of the GA with pH2.5 and concentrations of 3.0 mM, 10.0 mM and 15.0 mM respectively.

It can be seen from FIG. 8 that the bubble size of α-La alone increases with time in both the conditions of pH7.0 and pH2.5; however, the pH 2.5 causes a smaller reduction in the size of the remaining bubbles in α-La alone over a 30 min decay time compared to pH 7.0, where the surface charge is increased and thus facilitates absorption at the air/water interface based on improved protein-protein intermolecular interactions. In the presence of GA, α-La/GA composite (protein-based foaming agent) can produce bubbles with smaller size distribution, and the higher GA concentration has a more significant effect on the bubble size formed by α-La.Form stability is good when the diameter of the bubbles is small, suggesting that higher GA concentrations lead to more stable bubbles. As comparing to the condition of pH 7.0, α-La alone and α-La combined with GA form smaller bubbles in the condition of pH 2.5, which further confirms that the foam at pH 2.5 shows high stability in long-term storage, and such a property indicates a good application potential in foam food processing. In some embodiments, the protein-based foaming agent made of α-La and GA is used as food additive to generate bubbles in food, which makes the appearance of foamed food look fluffier and improves the appearance of foamed food. In some embodiments, the foam microstructure of protein can be adjusted by controlling the adding ratio of GA. It can be seen from Embodiment 11 that under the conditions of GA added is in an amount of 10.0 mM or 15mM (equivalent to the molar concentration ratio of α-La to GA of 1 : 500 or 1 : 750), in some embodiments, the bubbles formed by the composite are small, which ensures the foaming ability and foam stability of the protein to achieve the desired effect.

### Embodiment 12

### Effect of Different GA Adding Ratios on Interface Morphology of α-La Foam

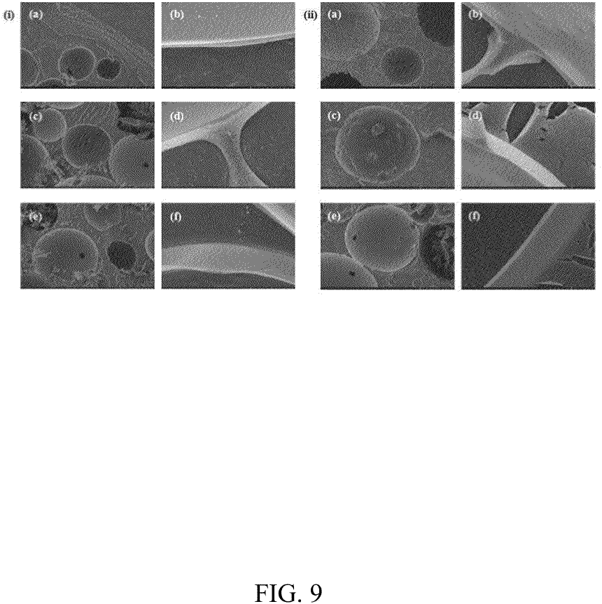

Observation of foaming agent interface morphology: observing the fresh foam stabilized by different foaming agent samples prepared in Embodiments 1 - 2 by freezing scanning electron microscope, where a small amount of fresh foam is fixed on the copper frame, and then the sample is quickly put into liquid nitrogen (208° C.) for freezing treatment; observing the microstructure of frozen foam by scanning electron microscope, where the observed results are shown in (i) and (ii) of FIG. 9 respectively; in (i) and (ii) of FIG. 9, (a) and (b) show the interface morphology of bubbles when the concentration of GA is 0 mM, (c) and (d) show the interface morphology of bubbles when the concentration of GA is 3 mM, and (e) and (f) show the interface morphology of bubbles when the concentration of GA is 10.0 mM, where the magnification of (a), (c) and (e) is 600 times and the magnification of (b), (d) and (f) is 20,000 times.

FIG. 9 presents the interface morphology of bubbles formed by α-La alone and α-La combined with GA. The stable bubble surface film of the test sample shows enough smoothness and uniformity, which indicates that protein molecules are fixed on the air/water interface. A thicker film layer is formed around the foam for α-La alone in the condition of pH 2.5 (FIG. 9(ii)) compared with pH 7.0 (FIG. 9(i)), and the film helps to avoid bubble coalescence and therefore stabilizes bubbles; it is speculated that the higher surface hydrophobicity of α-La in acidic solution can inhibit foam disproportionation, and finer foam can be formed without rapid collapse. As shown in (d) and (f) in (i) and (d) and (f) in (ii) of FIG. 9, there is a thicker interface layer around the foam of α-La/GA composite compared with α-La alone, and the layer can prevent coalescence in addition to low air diffusion between bubbles; such phenomenon may be explained by the strong adsorption of α-La and GA at the air/water interface in acidic solution, where he disproportionation and coalescence between bubbles are prevented and the foam stability is ensured. In some embodiments, the film layer of the foam of the composite can be adjusted by controlling the adding ratio of GA; for example, under the condition of GA of 10.0 mM (equivalent to the molar concentration ratio of α-La to GA of 1 : 500), the film layer formed by the composite is thicker, ensuring the stability of the foam; in some embodiments, under the condition of α-La concentration of 20 µM, the GA concentration is set at 10.0 mM (equivalent to the molar concentration ratio of α-La to GA of 1 : 500), and the pH value is adjusted to 2.5, the amount of GA is low in this case, the α-La has higher surface hydrophobicity and viscosity, the composite has higher aggregation degree and better foaming ability as well as foam stability, and the foam formed at this time is smaller in size and has higher stability; still, under the condition of α-La concentration of 20 µM, the GA concentration is set at 15.0 mM (equivalent to the molar concentration ratio of α-La to GA of 1 : 750) in some embodiments, and the pH value is adjusted to 2.5, a large dosage of GA is required at this time, the surface hydrophobicity and viscosity of α-La are both higher, the composite has higher aggregation degree and better foaming ability as well as foam stability, and the foam formed at this time is smaller in size and has higher stability.

The above are only the preferred embodiments of the present application, and the scope of protection of the present application is not limited thereto. Any person familiar with the technical field who makes equivalent substitution or change according to the technical scheme and inventive concept of the present application within the technical scope disclosed by the present application should be covered in the scope of protection of the present application.

1. A protein-based foaming agent, comprising alpha-lactalbumin (α-La) and glycyrrhizic acid (GA) as raw material, wherein a molar concentration ratio of the α-La to the GA in the protein-based foaming agent is in a range of 1:750 to 1:500; and
the protein-based foaming agent is prepared as follows: preparing an α-La solution with a concentration of 20 µM, adjusting pH of the α-La solution to 2.5, and then adding the GA for reaction to the pH-adjusted α-La solution to obtain the protein-based foaming agent.

2. A method for preparing the protein-based foaming agent according to claim 1, comprising: preparing an α-La solution with a concentration of 20 µM, adjusting pH of the α-La solution to 2.5, and then adding GA for reaction to the pH-adjusted α-La solution to obtain the protein-based foaming agent.

3. The method according to claim 2, wherein after adjusting pH of the α-La solution, the method includes standing the pH-adjusted α-La solution for 10-15 hours.

4. The method according to claim 2, wherein the reaction is carried out at room temperature for 20-40 minutes.

5. The method according to claim 2, wherein a molar concentration ratio of the α-La to GA in the protein-based foaming agent is 1:750.

6. The method according to claim 2, wherein a molar concentration ratio of the α-La to GA in the protein-based foaming agent is 1:500.

7. (canceled)

8. A method for preparing a protein-based foaming agent, comprising:
preparing an alpha-lactalbumin (α-La) solution with a concentration of 20 µM,
adjusting pH of the α-La solution to 2.5,
standing the pH-adjusted α-La solution for 12 hours,
adding glycyrrhizic acid (GA) for reaction with the pH-adjusted α-La solution, wherein a molar concentration ratio of the α-La to the GA in the protein-based foaming agent is 1:750; and
carrying out a reaction of the α-La and the GA at room temperature for 30 minutes to obtain the protein-based foaming agent.
